(19) United States
(12) Patent Application Publication
(10) Pub. No.: US 2007/0198250 A1
(43) Pub. Date: Aug. 23, 2007

(54) INFORMATION RETRIEVAL AND REPORTING METHOD SYSTEM

(76) Inventor: Michael Mardini, New York, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/676,941

(22) Filed: Feb. 20, 2007

Related U.S. Application Data
(60) Provisional application No. 60/775,059, filed on Feb. 21, 2006.

(51) Int. Cl. G06F 17/27; G06F 17/30; G06F 19/00; G06F 17/00

(52) U.S. Cl. 704/9; 715/507; 705/3; 707/3

(57) ABSTRACT

A method. The method including receiving medical information, and comparing electronic text representative of the medical information with information associated with a field of a report template. The method also includes populating the report template with at least a portion of the electronic text. The report template is populated when the electronic text includes a synonym, hypernym, hypoparonym and/or a paronym of a preselected term. The preselected term corresponds to a medical concept.

### CROSS-REFERENCE TO RELATED APPLICATIONS

This application claims priority to pending U.S. Provisional Application No. 60/775,059 entitled “Information Retrieval and Reporting Method and System” and filed Feb. 21, 2006, which is incorporated herein by reference in its entirety.

### BACKGROUND

1. Technical Field

The disclosed embodiments generally relate to the field of medical information retrieval and reporting.

2. Description of the Related Art

Many of the medical records that are collected and stored today are made up of notes taken by physicians or other medical practitioners. Currently most physicians generate notes describing their observations shortly after performing) surgery or other medical procedures, during or immediately following the examination of patients, or during the review and processing of medical images. Typically, these notes are dictated by the physician and later manually transcribed by a stenographer into a written report. The reports may be used for patient education, referral reports, marketing efforts, archiving, or to comply with regulatory requirements.

To speed up the transcription process, some template or macro-based reporting systems have been developed. In such systems the user generally initially selects fields, and then speaks, or dictates, the information required for the chosen field. In cases where speech recognition is used, without templates, the user typically must speak the entire report regardless of how much information being reported is normal, abnormal or even relevant to the end user. With templates, the user must still select from each predetermined field and then speak their new information into the selected area of the template. For example. U.S. Pat. No. 6,031,526, the disclosure of which is incorporated by reference herein in its entirety, describes the integration of video images with physician observations where the physician dictates his or her observations concerning the medical procedure and captured video frame, and a voice recognition module converts the dictated audio information verbatim into viewable and editable text which is combined in a word processing module with the captured video frame.

Additionally, current methods for access to medical information and educational materials by physicians consist of standard searching and indexed access methods, typically without integration to reporting applications or speech recognition systems. Moreover, a request for medical information necessary for diagnosis currently requires connection to several disparate systems using standard mechanisms of field searches with the exact request to find essential data. This is time consuming and often times results in decisions without essential data and information due to the complexity necessary to find it.

U.S. Pat. No. 6,738,784, the disclosure of which is incorporated by reference herein in its entirety, describes a document processing system operating through a remote public subscriber server that may use voice recognition software for the reporting of medical observations and diagnoses, and it uses natural language processing for the compilation of relevant information necessary to those working in a specific field. The subscription-based system receives voice files from a subscriber, transcribes the received voice files to text format, analyzes and processes the transcribed voice files using a natural language processing system applying knowledge based analysis for compiling the transcribed voice files, and collects the compiled transcribed voice tiles in a dynamic experiential database which processes the voice flies to add value thereto. While this system is capable of determining which form to use based on the dictated text, it does not go so far as automatically populating the fields based upon the dictated text. Moreover this system requires the matching of terms in order to compile relevant information to be included, and it searches only a dynamic experiential database in accordance with predetermined wishes of the subscriber.

The disclosure contained herein describes attempts to address one or more of the problems described above.

### SUMMARY

In one general respect, this application discloses a system. According to various embodiments, the system includes at least one computing device. The computing device includes a report module for comparing electronic text representative of medical information with a synonym, hypernym, a hypoparonym and/or a paronym of a preselected term. The preselected term corresponds to a medical concept.

In another general respect, this application discloses a method. According to various embodiments, the method includes receiving medical information, and comparing electronic text representative of the medical information with information associated with a field of a report template. The method also includes populating the report template with at least a portion of the electronic text. The report template is populated when the electronic text includes a synonym, hypernym, hypoparonym and/or a paronym of a preselected term. The preselected term corresponds to a medical concept.

According to other embodiments, the method includes receiving medical information, and identifying a portion of electronic text which includes a synonym hypernym, hypoparonym and/or a paronym of a preselected term. The preselected term corresponds to a medical concept. The method also includes identifying a document which includes a synonym, hypernym, hypoparonym and/or a paronym of the preselected term.

Aspects of the disclosed invention may be implemented by a computer system and/or by a computer program stored on a computer-readable medium. The computer-readable medium may comprise a disk, a device, and/or a propagated signal,

### BRIEF DESCRIPTION OF THE DRAWINGS

FIG. 1 illustrates various embodiments of a system.

FIG. 2 illustrates various embodiments of a report template.

FIG. 3 illustrates various embodiments of a method of building a report.

FIG. 4 illustrates various embodiments of a method of identifying relevant content.

FIG. 5 depicts illustrates various embodiments of a method of answering a question.

### DETAILED DESCRIPTION

Before the present methods, systems and materials are described, it is to be understood that this disclosure is not limited to the particular methodologies and systems described, as these may vary. It is also to be understood that the terminology used in the description is for the purpose of describing the particular versions or embodiments only, and is not intended to limit the scope,

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any method, materials, and devices similar or equivalent to those described herein can be used in the practice or testing of embodiments, the preferred methods, materials, and devices are now described. All publications mentioned herein are incorporated by reference. Nothing herein is to he construed as an admission that the embodiments described herein are not entitled to antedate such disclosure by virtue of prior invention.

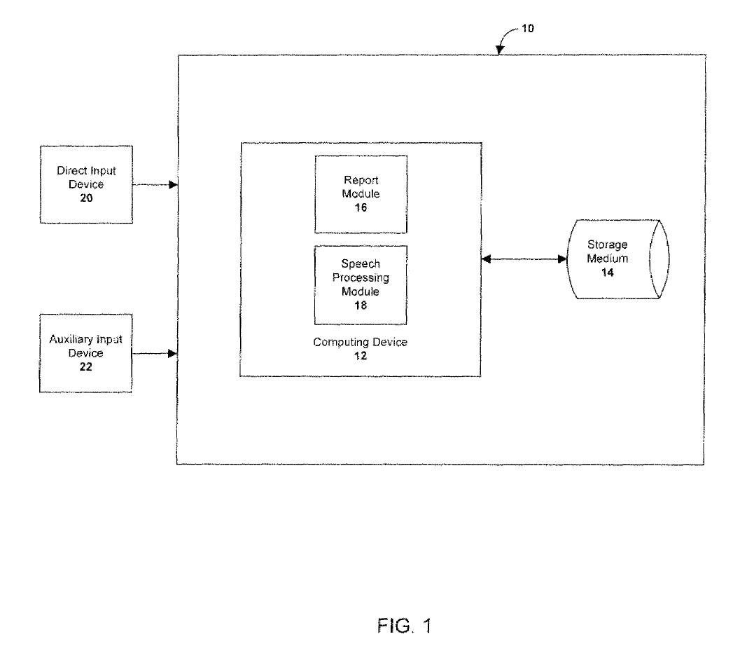

FIG. 1 illustrates various embodiments of a system 10. The system 10 may be, for example, an information reporting system. The system 10 comprises a computing device 12, and a storage medium 14 in communication with the computing device 12. The computing device 12 may be any type of computing device such as, for example a server. The computing device 12 comprises a report module 16. The report module 16 is configured for comparing electronic text representative of medical information with at least one of the following: a synonym of a preselected term, a hypernym of the preselected term, a hypoparonym of the preselected term, and a paronym of the preselected term, wherein the preselected term corresponds to a medical concept. The report module 16 may also he configured for populating a report template with at least a portion of the electronic text when the electronic text comprises at least one of the following: a synonym of the preselected term, a hypernym of the preselected term, a hypoparonym of the preselected term., and a paronym of the preselected term. According to various embodiments, the computing device 12 may further comprise a speech processing module 18 in communication with the report module 16 as shown in FIG. 1. The speech processing module 18 is configured for digitizing medical information into electronic text.

Each of the modules 16, 18 may be implemented in hardware or in firmware. According to various embodiments, the modules 16, 18 may be implemented as software applications, computer programs, etc. utilizing any suitable computer language (e.g., C, C++, Delphi, Java. JavaScript, Perl, Visual Basic, VBScript, etc.) and may be embodied permanently or temporarily it any type of machine, component, physical or virtual equipment, storage medium, or propagated signal capable of delivering instructions to a device. T he software code may be stored as a series of instructions or commands on a computer-readable medium such that when a processor reads the medium, the functions described herein are performed. As used herein, the term “computer-readable medium” may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more propagated signals, and such propagated signals may or may not be transmitted on one or more carrier waves. Although the modules 16, 18 are shown in FIG. 1 as two separate modules, one skilled in the art will appreciate that the functionality of the modules 16, 18 may be combined into a single module.

The storage medium 14 may be any type of storage medium, and may store information pertaining to one or more preselected terms. According to various embodiments, each preselected term corresponds to a respective medical concept. For a given preselected term, the information may comprise the given preselected term, one or more synonyms of the preselected term, one or more hypernyms of the preselected term, one or more hypoparonyms of the preselected term, one or more paronyms of the preselected term, or any combination thereof. According to various embodiments, the storage medium 14 may also store information pertaining to various medical concepts, and/or information pertaining to one or more report templates. The report templates are described in more detail hereinbelow. Although the storage medium 14 is shown as being apart from the computing device 12 in FIG. 1, those skilled in the art will appreciate that according to other embodiments, the storage medium 14 may comprise a portion of the computing device 12.

When meeting with a patient, a medical practitioner, such as a physician, medical resident, nurse, nurse practitioner, dentist, medical resident, physician's assistant or other professional may create text that includes notes or comments relating to the practitioners observations about a patient. The medical practitioner may enter such information directly into the system 10 via a direct input device 20 such as a keyboard, touch screen, electronic tablet or microphone. Alternatively, the medical practitioner may enter the information into a separate device such as a voice recorder, personal digital assistant (PDA) or separate device, and the recorded text or speech may be entered into the system 10 via an auxiliary input device 22 such as a disk drive, universal serial bus (USB) port, analog or digital telephone, VOIP system, modem and Internet (or other network) connection or other device. Utilizing the direct or auxiliary input of speech may reduce the time that the practitioner must spend taking notes.

If the practitioner's information is dictated, the speech may be digitized into a data stream and processed by the speech processing module 18. An example of a speech recognition system is described in U.S. Pat. No. 6,031,526. the disclosure of which is incorporated by reference herein in its entirety, although any conventional or other speech recognition system may be used. The speech processing module 18 may recognize patterns corresponding to specific words or phrases within the digitized data stream, Based on the recognized patterns, the speech processing module 18 may create an electronic text containing digitized character and formatting codes that may be recognized by word processing software, such as Microsoft Word, or other rich text file (“RTF”) applications.

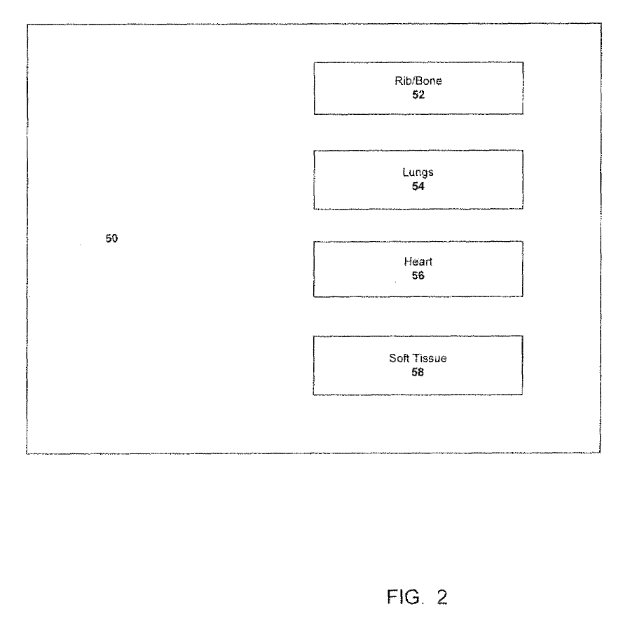

After the practitioner's speech has been processed into electronic text, or after text is directly entered (for embodiments where the practitioner's notes are already available in electronic text form so that speech processing is not required), the electronic text may be delivered to the report module 16. The report module 16 may compare the electronic text to the information stored in the storage medium 14 to determine whether the electronic text includes any of the information stored in the storage medium 14. The report module 16 may utilize the results of the comparison to determine whether some or all of the text should be placed in one or more fields of a report. The report module 16 may use a report template to serve as a baseline for the positioning of relevant text into the report. The report template may be predetermined (such as via matching to appropriate procedure codes of the examination(s) performed, patient symptoms, patient location and/or patient demographics), or optionally a user may select from various available report templates. According to various embodiments, the report template may be selected by using an exam code to identify the type of exam and associated report template. A report template may include a file or electronic representation of a document, where the document contains various fields in which certain categories of information may be entered. For example, FIG. 2 illustrates various embodiments of a radiology report template 50. The radiology report template comprises fields where information relating to practitioner observations concerning to various aspects of the patient's health may be populated. Such fields may include, for example a rib/bone field 52, a lungs field 54, a heart field 56, and a soft tissue field 58.

Similarly, a medical resonance imaging (MRI) brain template may include observation fields such as supratentorial, infratentorial, midline structures. extra-axial structures and spaces, skull and scalp, bone structures, sinuses and vessels. As another example, a CT abdomen template may include observation fields such as visible lung fields, upper digestive tract, small bowel, colon, solid organs, vessels, retroperitoneal lymph nodes, bone and muscle structures, and genitourinary system.

Each field in the report template may be associated with one or more medical concepts that help the system 10 determine the text that is to be associated with the field. Based on the text segment terms and the known medical concepts for the template fields, if a sentence or paragraph is found to contain one or more words corresponding to a medical concept, the system may insert that sentence or paragraph in the associated subsection or field of the report template. Many reports may require the practitioner to insert text into certain fields, or into all fields, of a report. If the dictated information does not contain any of the terms associated with a particular medical concept, the subsection may display default text for that fields For example, the default text may be a simple phrase such as “normal”, or it may indicate an absence of action, such as “not observed.”

Referring to FIGS. 1 and 2, the report module 16 may select text for population within a field by searching for the words that match template medical concepts. For example the report 50 may include a field for heart observations 56 such as “Mild Cardiomegaly.” During or after an analysis of a medical image, a surgical procedure or a patient observation, a user such as a physician may enter all observation via a microphone or other input device. Each subsection within the report template may be preprogrammed lo recognize particular terms (or term segments such as those determined by the previously created hypoparonym hierarchies) that consist of at least one word associated with that subsection. In accordance with the example of FIG. 2, the subsection for imaging associated with the heart may recognize the term “cardiac” and the term “valvular” as associated with that subsection. If the information is typed, and a text segment (such as sentence or paragraph) is found to contain one or more of the preselected words or word segments, that text segment may be entered into the associated field of the report template.

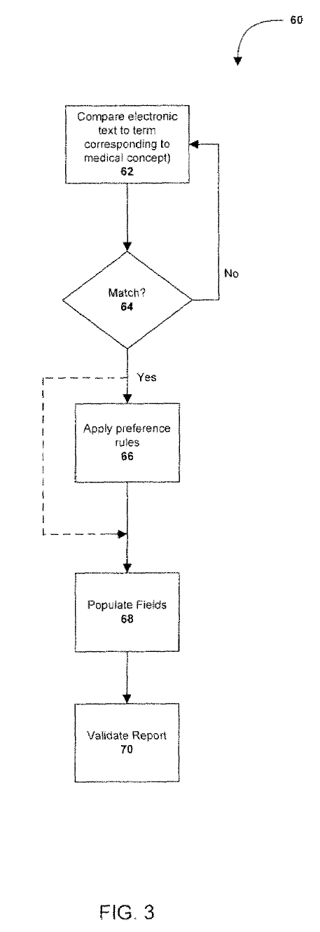

FIG. 3 illustrates various embodiments of a method 60 of building a report template. The method 60 may be implemented by the system 10 of FIG. 1. For ease of explanation purposes, the method will be described with respect to the building of a medical report template. However, those skilled in the art will appreciate that the method may be utilized to build other report templates. Once the electronic text corresponding to the medical observation is generated, the report building process advances to block 62, where the text is compared to terms which correspond to a medical concept. The text may be compared to terms which are exact matches or synonyms of the terms associated with the medical concept. Additionally, the text may also be compared to any analogous terms such as hypoparonyms, hypernyms and paronyms of the medical concepts. Hypernyms, paronyms and hypoparonyms may be used to determine the fields that are relevant to a particular text segment. For example, if the medical concept for a field is “heart, ” the hypoparonyms of “heart” that may be included in the preselected term search may be “cardi-”, “myocar-”, “pericar-”, “papillar-” “valv-”, and “ventr-” and hypernym for all of these hypernym for all of these hypoparonyms would be “heart.” Thus, a text segment containing words having any of these hypoparonyms may be designated as appropriate for the fields. Similarly, if a hied has a medical concept of “kidney”, relevant hypoparonyms may include “rena-,”, “nephr-”, “kid-” and “pyelo-”.

According to various embodiments, the terms corresponding to the medical concepts may be preselected, and the terms may be stored in the storage medium 14 as, for example, a list, a chart etc. According to various embodiments, the terms may be stored directly in a field of a report template. The comparison performed at block 62 may be performed on a segment by segment basis, a word by word basis, a sentence by sentence basis, a paragraph by paragraph basis, or any variation thereof.

From block 62, the process may advance to block 64, where it is determined whether or not any portions of the electronic text match any of the terms corresponding to the medical concept. According to various embodiments, a given portion of the electronic text is deemed to match a term corresponding to the medical concept if the given portion of the electronic text comprises at least one word segment, word, or a specific number of words corresponding to the medical concept. The deeming of a match may also be based on a predetermined threshold level.

From block 64, the process may return to block 62 or advance to block 66. If the process at block 64 deems that the portion of the text does not match any of the terms corresponding to the medical concept, the process returns to block 62, where the process advantages as described hereinabove. However, if the process at block 64 deems that the portion of the text does match any of the terms corresponding to the medical concept, the process advances to block 66, where one or more preference and/or ranking rules may be applied to the matching text. The rules may be used to determine whether to include a particular text segment within a field of the report template, whether the text segment should appear in multiple fields, or whether a text segment is more likely to relate to one field than another. If the text includes hypoparonyms corresponding to different fields, the preference and/or ranking rules may determine in which field the text is to be populated. The matched phrases may also be populated into the Impression section of the resulting report text.

From block 66, the process advances to block 68, where the matching electronic text is populated into one or more fields of the report template. The process flow described in blocks 62-68 may continue until each subsection of the report template is populated either with portions of the electronic text or default text. According to various embodiments, no preference and/or ranking rules are applied to the matching text. For such embodiments, the process advances directly from block 64 to block 68.

From block 68, the process advances to block 70, where the generated report is validated. The validation may be performed by the practitioner or another individual, and may include a review and revision of the information populated in the various fields of the report. Prior to the validation, the report may the transmitted or delivered to the person who validates the report. The report may also be downloaded or stored in an information system containing reports of similar type.

In some embodiments, the process shown in FIG. 3 may be performed on stored text. In other embodiments, the process may be performed substantially in real-time, as the practitioner speaks or enters the observations, with speech processing and report formatting occuring while the practitioner records the observations, so that the practitioner will have immediate or otherwise quick access to a draft report for validation.

For example, a radiologist may view a CT scan and comment on the liver and spleen. The radiologist may state that the liver is normal, but there is fracture and mass in the spleen. The radiologist's comments can then be turned into written text, The radiologist may want the written text inserted into a template associated with a CT scan test. The template may contain a liver field with a default stating that the liver is normal. The system may search the written text every few words, every paragraph, or some other segment. The system may search for words such as liver or analogous terms, such as hypoparonyms, hypernyms and paronyms of liver, to determine if there is a match. The analogous terms may be stored in a database. If there is a match between the words in the database and the written text, the sentence or paragraph of the written text may be included in the field of the report and replace the default.

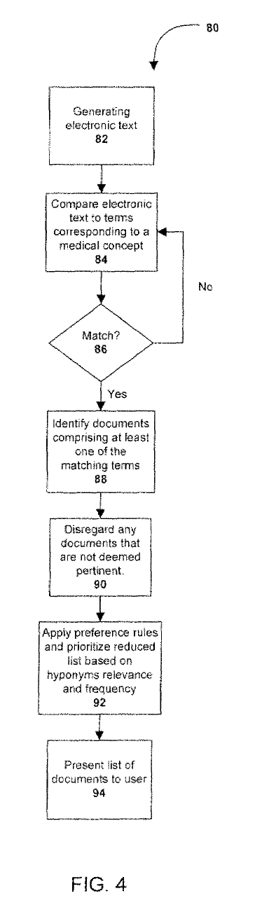

FIG. 4 illustrates various embodiments of a method 80. The method 80 may be implementing using the system 10 of FIG. 1 and may be utilized to analyze text and identify relevant documents. For the ease of explanation purposes, the method will be described with respect to identifying a medical document from a database of medical documents. However, those skilled in the art will appreciate that the method may he utilized to identify other content.

The process begins at block 82 where the electronic text corresponding to a medical concept is generated. The electronic text may be representative of a statement or question posed from any suitable party. A suitable party may include, but is not limited to, a medical practitioner, patient, insurance representative, or any other person seeking medical information.

From block 82, the process advances to block 84 where the text is compared to terms which correspond to a medical concept. According to various embodiments, the terms may be stored at the content database 24 of FIG. 1. The comparison may include a comparison with terms which are hypernyms, paronyms, and hypoparonyms of a term corresponding to a medical concept.

From block 84, the process may advance to block 864, where it is determined whether or not any portions of the electronic text match any of the terms corresponding to the medical concept. According to various embodiments, a given portion of the electronic text is deemed to match a term corresponding to the medical concept if the given portion of the electronic text comprises at least one word segment, word, or a specific number of words corresponding to the medical concept. The deeming of a match may also be based on a predetermined threshold level.

From block 86, the process may return to block 84, or advance to block 88. If the process at block 86 deems that the portion of the text does not match any of the terms corresponding to the medical concept, the process returns to block 84, where the process advances as described hereinabove.

If there is a match, the process advances from block 86 to block 88 where documents which include at least one of the matching terms are identified. The documents may be stored, for example, in the content database of FIG. 1 and may be associated with one or more medical concepts. Based on the text segment terms and the medical concepts, if a sentence or paragraph of the electronic text contains one or more words corresponding to a medical concept, one or more documents that are associated with the medical concept from the database may identified. A document may be relevant to a text segment based on whether the text segment and the document's medical concepts contain any direct matches, synonyms, hypernyms, paronyms and hypoparonyms. From block 88, the process advances to block 90, where any documents that are not deemed pertinent to the medical concept may be disregarded.

After reducing the list of matching documents at block 90 the process advances to block 92, where the preference rules and priorities are applied to further reduce the identified documents based on hypernym relevance and frequency. One or more additional preference and/or ranking rules are applied to the medical concepts and text segment to determine whether certain documents should be removed from the list, or to determine the ranking of documents within the list. These matching concepts are typically organized via a prioritization process determined by the frequency and relevance of the matched hypernym terms. Lastly, after the preference rules are applied at block 92, the process advances to block 94, where the documents may be presented to a user. The documents may be presented as, for example, a list, a chart, a table, a graphical image, or any combination thereof.

In some embodiments, the process shown in FIG. 4 may be performed on stored text. In other embodiments, the process may be performed substantially in real-time, as the practitioner speaks or enters the observations with speech processing and report formatting occuring while the practitioner records the observations, so that the practitioner will have immediate otherwise quick access to a result. Optionally, the steps described above may be performed in a different order, or they may be performed simultaneously.

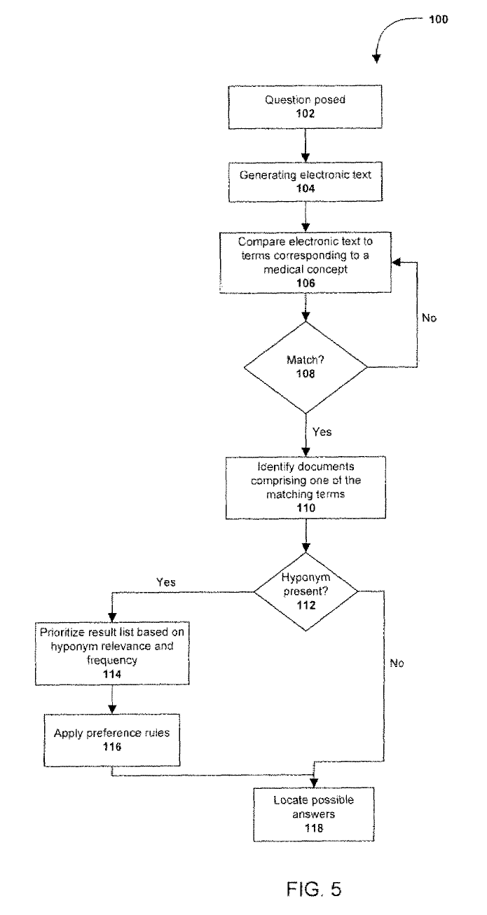

FIG. 5 illustrates various embodiments of a method 100. The method 100 may be implemented using the system 10 of FIG. 1 and may be utilized to analyze questions and identifying relevant documents which provide the answers. For the ease of explanation purposes, the method will be described with respect to identifying a medical document from a database of medical documents. However, those skilled in the art will appreciate that the method may be utilized to identify other content.

The process begins at block 102 where a question is posed. The question may be posed from any suitable party. A suitable party may include, for example, a medical practitioner, patient, insurance representative, or any other person seeking medical information. From block 102, the process then advances to block 104, where electronic text representative of the question is generated.

After the electronic text is generated, the process advances from block 104 to block 106 where the text is compared to terms corresponding with a medical concept. According to various embodiments, the terms may be stored at the content database 24 of FIG. 1. For example, if the question for a field is associated with a “heart,” the hypoparonyms of “heart” that may be included in the preselected term search may be “cardi-”, “myocar-”, “pericar-”, “papillar-” “valv-”, and “ventr-” and a hypernym may be “cardiac muscle.” Thus, a text segment containing words having any of these hypoparonyms may be designated as appropriate for the question. Similarly, if a field has a medical concept of “kidney”, relevant hypoparonyms may include “rena-”, “nephr-”, “kid-” and “pyelo-”.

According to various embodiments, the question may contain an anatomical reference or a pathological reference. If the question contains an anatomical reference and a medical observation or finding, the question may be interpreted as asking what conditions can cause the particular finding in the particular part of the anatomy. For example, certain key terms, such as “cardiac muscle” will be associated as anatomical, and certain key terms, such as “cardio-vascular disease” will be associated as pathological. In some embodiments, the architecture may allow for the question categories to be expanded at any time. Examples of question categories may include, and are not limited to: Anatomy, Pathology, Differential Diagnosis, Teaching File, General Internet Search, Image-based Internet Search, Patient Record Search, Departmental Record Search and Hospital Enterprise Search.

Any or all of the hypernyms and hypoparonyms, hypernyms and hypoparonyms, paronyms, and synonyms of the preselected terms may be used. Alternatively, or additionally, fuzzy access to search medical information at the time of diagnosis via speech recognition at the time of dictation may be used. Thus, if the precoded and preindexed content contains the preselected terms or their analogous terms, the document or File connected with the precoded or preindexed content may be delivered to a user. In some embodiments, a user need not specifically ask for the content, as the system 10 may interpret the user's speech and select the content via the analogous terms, subsequent index, search and content relevant retrieval.

Various search methods may be used which include, but are not limited to, the utilization of metadata or ontology inference objects for searching. Metadata, for example, has become common in search technology because of the need to find useful information from the mass of information available. Manually-created metadata adds value because it ensures consistency. If one webpage about a topic contains a word or phrase, then all webpages about that topic should contain that same word. It also ensures variety, so that if one topic has two names, each of these names will be used. Metadata is often called ontology or schema when it is structured into a hierarchical arrangement, and both terms describe “what exists” for some purpose or to enable some action, such as how more specialized topics are related to or derived from more general subject headings,

From block 106, the process advances to block 108, where it is determined if a text segment matches with the electronic text. According to various embodiments, the text segment is deemed to match the question if it contains at least one such word or word segment. Alternatively, the text segment may be deem ed to match by having a specific number of words or word segments based on a predetermined threshold level.

From block 108, the process may return to block 106 or advance to block 110. If the process at block 108 deems that the portion of the text does not match any of the terms corresponding to the medical concept, the process returns to block 106 where the process advances as described hereinabove.

Alternatively, the process may advance to block 110 lo identify documents comprising at least one of the matching terms. From block 107 the process advances to block 112, where it is determined if one or more hypernyms are present in the documents identified in block 110. From block 112, the process may advance to block 114 or to block 118.

If one or more hyponyms are not present in an identified document, the process advances from block 112 to block 118. However, if one or more hyponyms are present in the identified document the process for advances from block 112 to block 114 where the specified matched hyponyms and their associated hierarchical hyponyms may be used to reduce the number of identified documents. In addition, the result list may be prioritized at block 114 based on hyponym relevance and frequency. From block 114, the process advances to block 116, where preference rules are applied. One or more additional preference and/or ranking rules may be applied to the text segment to determine whether to associate a text segment with a question, whether the text segment relates to multiple questions, or whether a text segment is more likely to relate to one question than another.

From block 116, the process advances to block 19X, where possible answers within the identified documents are located. According to various embodiments, the answers may then be presented to a user. After the question is generated, a file or other output may be provided as an answer to the question. Optionally, multiple options may be presented to the user, as a search engine may present its information to a user, in various orders such as ranking by potential relevance.

What has been described and illustrated herein includes various embodiments of the invention along smith some of their variations. The terms, descriptions, and figures used herein are set forth by way of illustration only and are not meant as limitations. Those skilled in the art will recognize that many variations are possible within the spirit and scope of the invention, which is intended to be defined by the claims and their equivalents in which all terms are meant in their broadest reasonable sense unless otherwise indicated. For example, the methods described in FIG. 3-5 may be completed in a different order in alternative embodiments.

What is claimed is:

1. A method, comprising:
receiving medical information;
comparing electronic text representative of the medical information with information associated with a field of a report template and
populating the report template with at least a portion of the electronic text when the electronic text comprises at least one of the following:
a synonym of a preselected term, wherein the preselected term corresponds to a medical concept;
a hypernym of the preselected term-;
a hypoparonym of the preselected term; and
a paronym of the preselected term.

2. The method of claim 1, wherein receiving the medical information comprises receiving the information in a digital format.

3. The method of claim 1, wherein receiving the medical information comprises receiving the information in an analog format.

4. The method of claim 3, further comprising converting the received medical information into the electronic text.

5. The method of claim 4, wherein converting the received medical information comprises generating a digitized data stream representative of the received medical information.

6. The method of claim 1, wherein comparing the electronic text comprises comparing on a sentence by sentence basis.

7. The method of claim 1, wherein comparing the electronic text comprises comparing on a paragraph by paragraph basis.

8. The method of claim 1, wherein comparing the electronic text comprises comparing the electronic text in real time.

9. The method of claim 1, wherein populating comprises populating the template when the electronic text comprises the preselected term.

10. The method of claim 1, wherein populating comprises populating at least two different fields of the report template when the electronic text comprises at least two different preselected terms which respectively correspond to different medical concepts.

11. The method to claim 1, further comprising receiving, a report template selection prior to populating the report template.

12. The method of claim 1 further comprising applying at least one of the following to the electronic text:
a preference rule; and
a ranking rule.

13. The method of claim 1, further comprising populating a field of the report template with default text when the electronic text does not comprise the preselected term.

14. The method of claim 1, further comprising generating a medical report.

15. A method, comprising:
receiving medical information;
identifying a portion of electronic text that comprises at least one of the following:
a synonym of a preselected term, wherein the preselected term corresponds to a medical concept;
a hypernym of the preselected term;
a hypoparonym of the preselected term; and
a paronym of the preselected term; and
identifying a document comprising at least one of the following;
a synonym of the preselected term:
a hypernym of the preselected term;
a hypoparonym of the preselected term; and
a paronym of the preselected term.

16. The method of claim 15 wherein identifying the document comprises identifying a plurality of documents each of which comprise at least one of the following:
a synonym of the preselected term,
a hypernym of the preselected term;
a hypoparonym of the preselected term; and
a paronym of the preselected term.

17. The method of claim 16, further comprising disregarding at least one of the documents to include only those documents deemed pertinent.

18. The method of claim 15, further comprising presenting the document to a user.

19. A system, comprising:
at least one computing device, wherein the computing device comprises a report module for comparing electronic text representative of medical information with at least one of the following:
a synonym of a preselected term, wherein the preselected term corresponds to a medical concept;
a hypernym of the preselected term:
a hypoparonym of the preselected term; and
a paronym of the preselected term.

20. The system of claim 19, wherein the report module is for populating a report template with at least a portion of the electronic text when the electronic text comprises at least one of the following:
a synonym of the preselected term;
a hypernym of the preselected term;
a hypoparonym of the preselected term; and
a paronym of the preselected term.

21. The system of claim 19, further comprising a speech recognition module in communication with the report module, wherein the speech recognition module is for digitizing medical information into electronic text.
